(19) United States
(12) Patent Application Publication
(10) Pub. No.: US 2012/0280144 A1
(43) Pub. Date: Nov. 8, 2012

(54) OPTICAL SYSTEM ENABLING LOW POWER EXCITATION AND HIGH SENSITIVITY DETECTION OF NEAR INFRARED TO VISIBLE UPCONVERSION PHOSHORS

(76) Inventors: Richard A. Guilfoyle, Zephyr Cove, NV (US); Peter S. Guilfoyle, Zephyr Cove, NV (US)

(21) Appl. No.: 13/433,087

(22) Filed: Mar. 28, 2012

Related U.S. Application Data
(60) Provisional application No. 61/468,994, filed on Mar. 29, 2011.

(51) Int. Cl. G01N 21/64

(52) U.S. Cl. 250/458.1; 250/206; 250/208.1

(57) ABSTRACT

A simple yet high performance optical system is described which is tailored to enabling efficient detection of the luminescence emissions of near infrared-to-visible upconverting phosphors. The system is comprised of simple and relatively low cost optical components and is designed to telecentrically enable low optical power NIR excitation and high sensitivity VIS and NIR detection of the upconverting phosphor (UCPs), particularly the lanthanide doped UCP nanocrystals which show great promise for utility as molecular taggants in many applications of biomedicine, security and environmental monitoring. The overall system is designed to facilitate compact spectrophotometric instrument manufacture and is adaptable to multiple liquid or solid sample types and formats.

### PRIORITY

The present application claims priority under 35 U.S.C. §119(e) from provisional application No. 61/468,994, filed Mar. 29, 2011.

### GOVERNMENT INTERESTS

This body of work was originally supported by the Air Force Research Laboratory, contract no. FA8750-05-C-0110.

### BACKGROUND OF THE INVENTION

The use of upconverting nanophosphors (UCPs) as photoluminescent tags is proving to be a superior alternative to the use of fluorescent dyes and semiconductor emitters (quantum dots) in many biomedical applications ranging from drug discovery to diagnostics. The excitation wavelengths of most fluorophores used as well as many typical phosphors are in either the visible or ultraviolet range of the electromagnetic spectrum and can damage biological samples as well as generate high levels of broadband background fluorescence in them (autofluorescence), severely degrading signal-to-noise (S/N) and thus also necessitating post signal processing. Quantum dots (QDs), on the other hand, although very bright suffer from intermittent blinking and can be toxic to humans. Also, both fluorescent dyes and quantum dots can photo-bleach at higher excitation intensities. The UCPs are an emerging class of nanoscale rare-earth-based phosphors which overcome these drawbacks (Wu et al.) and promise to dramatically improve performance across not only biomedical applications but others ranging from security to environmental monitoring to cosmetics. This is because they consist of a host crystalline material like yttrium oxy sulfide (Y₂O₂S) or NaYF₄ co-doped with trivalent lanthanide elements such as ytterbium (Yb3+), erbium (Er3+) and which absorb photons at near-infrared (NIR) wavelengths and re-emit at higher frequencies (typically visible wavelengths) without photo-bleaching. As a result of this NIR-to-visible upconversion process, or “anti-Stokes” behavior which uses a two-photon (sequential) absorbing mechanism that exists nowhere in natural biological material, they also do not induce autofluorescence, are insensitive to buffers or environment and therefore deliver greatly improved S/N in biological assays This in turn enables simplified assay designs and test sample preparations of complex specimen matrices such as tissue, whole blood, soil or food. Compared to fluorophores and QDs which are UV-to-VIS or VIS-to-VIS downconverters with broad highly overlapping excitation and emission profiles other UCP benefits include much narrower emission bands and large ant-stokes distances between them, thus often eliminating spectral overlaps and any requirement for band-pass filters. These spectral advantages particularly assist in facilitating the development of multiplexed assays. The UCPs can also be compositionally tuned to emit several different colors in the visible under a single NIR excitation wavelength such as provided by a 976 nm laser diode (the ytterbium ground state absorption maximum). They can also be tuned to absorb/excite at different wavelengths to yield both new upconversion and downconversion emissions in both the infrared and visible regimes.

Besides spectral absorbance and emission, other parameters can also be adjusted to produce unique spectral signatures such as rise time, decay time, power-density output and size. Their phosphorescent emission mechanism is based on energy migration between dopants, and therefore brightness can be increased by optimizing dopant concentrations and ratios as well as particle diameter or volume. For biological or security applications an enormous benefit is therefore realized in that the user could perform “multiplexed assays”, that is, simultaneous interrogation of integrated multiple spectrally distinguishable UCPs in a single system. Furthermore, to serve as reporters the nanophosphors can be functionalized such as by biotinylation, amino or carboxyl group derivatization for the attachment of any number of biological tags such as antibodies or oligonucleotides for multiplexed in vitro or in vivo molecular diagnostic or immunodiagnostic detection of specific analytes. Being able to perform streamlined, multiplexed assays under single excitation-λ should prove to be especially beneficial to the design of lower-cost and/or more accurate devices for high throughput screening in both clinical diagnostics and pharmaceutical discovery as well as for point-of-care-testing (POCT) or field-deployed monitoring applications. For a security application such as anti-counterfeiting, one can easily imagine thin films of multiplexed nanophosphors being applied directly at certain densities on surfaces such as brand products, identification/credit cards, electronic parts and currency. Authenticity as well as no possibility of reverse engineering could be guaranteed by encrypting with choices of the limitless number of spectral signatures (or code sequences) just a small number of UCP emissions could provide. For example, by using only the 3 parameters of wavelength (λ) emission intensity at peak rise time (I₀) and lifetime decay constant (T) unique to each of only 5 different color upconverters it would be possible to generate 15! or a trillion code sequences. Just adding one more parameter, such as rise time, would yield 2.4×10̂18 unique signatures. Because of their relatively long phosphorescence decays (in the microseconds) compared to fluorescence (nanosecond timescale), the design and manufacture of an upconverting phosphorimeter which multiplexes these parameters would be fairly simple and straight forward.

Only recently has the synthesis and commercialization of uniform, monodisperse and hydrocolloidal upconverting nanophosphors been realized, and down to sizes as small as 10 nanometers even with functionalized coatings without losing brightness applicable to the aforementioned applications. The main class of UCPs being commercialized is the lanthanide series where Yb3+ can act as sensitizer to absorb NIR light and which can be transferred to energy levels of Er3+, Ho3+ and Tm3+, or NdTm to emit red, green, blue or NIR (800 nm) light. However because these UCPs are just now beginning to emerge in the marketplace, instrumentation has yet to be developed with optimal performance tailored to their detection. For users this has been particularly problematic because most integrated spectrometry or microscopy based platforms on the market today are not broadband enough to accommodate the entirety of the VIS-NIR spectrum needed for both the excitation and detection of these nanoparticles. Most instruments both excite and detect in either the visible or near infrared, but rarely in both. One exception is what is known as “multi-photon microscopy” which upconverts certain materials from NIR wavelengths and depends on the simultaneous absorption of two or more photons and requires the use of expensive high power pulsed lasers and single channel detectors. The long-λ excitation does minimize auto-fluorescence, but the low incidence of multi-photon absorption necessitates input fluxes≧100 W/cm² which can damage biological materials. Investigators can use filters to remove background noise, but this further limits system throughput, while removal of the noise via post processing slows the analysis process.

The UCPs, on the other hand, use sequential two-photon absorption and only require a low power continuous wave (CW) light source for their excitation. Their phosphorescence cross section (Chen et al.) is equal to the ratio of the emitted power to the excitation intensity. At low intensities, the emission increases as the square of the laser intensity (the quadratic range), while at higher intensities emission increases linearly with intensity (the “saturation” range). Only moderate CW laser intensities of a few to a hundred watts per square centimeter are needed to generate sufficiently detected emission photons. For example, only a 0.5-2 milliwatt beam from a low-cost, low-power (fiber-pigtailed) laser diode (LD) or vertical cavity surface emitting laser (VCSEL) which is highly focused to a submillimeter spot size is needed to achieve saturation of the nanocrystals. Using a fiber-coupled multi-mode 976 nm 7.5 mW VCSEL as excitation source the inventors were easily able to cover the full quadratic 2-photon absorption range of a 540 nm-emitting UCP (NaYF4:Yb3⁺Er3⁺) and achieve saturation at only 0.6 mW of optical power and power density of 20 W/cm² (Log W/cm²=1.3 data point in FIG. 5.) in a low-cost plastic microfluidic cuvette of 25 microliter sample volume and 500 μm pathlength. FIG. 5A shows a log plot of the emission intensity as a function of excitation intensity in this experiment which used the “T-mode” prototype (depicted in FIG. 2). A higher power pump laser diode (300 mW maximum optical power) was used to produce the higher power densities required to complete the curve in the saturation range. FIG. 5B shows the curve broken down as linear log plots to expose the quadratic 2-photon absorption region (slope=2) and saturation region (slope≦1). In this case it required focusing the beam to a spot size nearly equivalent to the diameter of the fiber aperture (core diameter 62.5 microns) using only a pair of inexpensive simple plano-convex lenses of appropriate numerical aperture. Another advantage it follows therefore is the enablement of the usage of micro-scale sample volumes and dimensions. As part of an overall lens system, the photoluminescent emission signal was similarly focused onto an output fiber of same pupil size and measured as a highly resolved band in a mini-spectrometer equipped with a high pixel density CCD linear sensor array with sensitivity to a fairly broad spectral range (375-1100 nm). Traditionally investigators have retrofitted, for example, very expensive UV-VIS spectrophotometers, spectrofluorometers or fluorescence microscopes with high power near-infrared lasers or broadband light source with interference filters to obtain selective excitation wavelength and power densities adequate enough for UCP emission detection. Alternatively, confocal microscopes have also been used to achieve highly focused beams down to diffraction limited spot sizes but mostly in cases where, however, the only the real practical application is UCP single-molecule photophysical research. The retrofitting modifications typically introduced into existing instruments to be able to read UCPs in any of these systems are typically not compatible with their system optics in terms of achieving optimal performance. Furthermore they are bulky with very expensive and often complex optics, not clinically applicable nor scalable in form factor for the development of affordable bench-top or portable readers and are only generally suitable only for the research laboratory. Most fluorescence detection systems require the use of fairly low intensity excitation with collimated source light to avoid photobleaching and signal quenching of the fluorophores which typically takes place at higher intensities. It is the inventors' experience that albeit these systems can detect the phosphors, for instance when modified with a 980 nm light source, but poorly regardless of intensity because of their incompatible optics for achieving optimal performance in the UCP application. Thus a major advantage over designing systems for fluorescence detection is that unlike fluorophores the phosphors do not photobleach, and optics for focusing the beam onto the sample to enable higher optical power densities in not a concern for achieving optimal excitation, emission and detection of the UCPs in the linear saturation range of their luminescent cross sections. Furthermore, focusing the excitation beam to a fine point enables the interrogation of submillimeter sample path lengths and microliter volumes, a capability not available in most spectrofluorometric systems available. The invention described herein is a modular optical system design permitting the use of simple, low-cost optical components and facile fiber optic interconnects to relatively low-cost excitation sources and detectors and enabling a platform which eliminates the above described problems and which is tailored to cost-effectively achieving optimal excitation and detection of at least the Yb3+ sensitized (˜980 nm) upconverting phosphors in the preferred embodiment. The system described herein is designed for UCP spectra and band intensity readouts and does not address the measurement of their lifetimes. However, it is intended that the invention could also be easily tailored to enabling the detection of phosphors or nanophosphors, either upconverting or downconverting, having other excitation and emission wavelength characteristics requiring in turn the use of appropriate spectrally matching light sources and detectors. (Other optical designs have been proposed in the prior art (laser excitation techniques described in the patents of Kardos et al. and Zarling et al.). As the UCP markets grow so will the demand for new and supporting instrumentation tailored to applications based on UCP detection maximized for cost-performance ratio, and the invention described herein is designed for this purpose.

### BRIEF SUMMARY OF THE INVENTION

The present invention is summarized as consisting in part of a module design of optical components permitting low power excitation and high sensitivity detection of upconverting phosphors (UCPs) in the preferred embodiment and which is easily integrated as part of an overall spectrophotometric system via optical fiber interconnects to commercially available excitation light sources and detectors. In the preferred embodiment, the light source is a near infrared laser diode of wavelength 976-980 nm to activate Yb3+ sensitized (nano)phosphors and the detector is a mini-spectrometer equipped with a photodiode array such as a CCD linear image sensor which is broadband enough to detect and separate discrete phosphor emissions within the 400-850 nm electromagnetic spectrum encompassing the typical luminescent emission spectra of the NIR-to-VIS upconverting (nano)phosphors. The invented optical module is a lens system with optical filters which is telecentric in effect for focusing the excitation beam of the input fiber coupled laser to a fine point onto the phosphor-containing sample enabling the absorption/excitation intensities required to achieve their optimal luminescent emission intensities. Likewise, the intensities of phosphorescent emissions are concentrated to a fine point of similar size onto the output fiber coupled to the minispectrometer.

The drawing of FIG. 1 depicts a schematic of the optical module required for focusing the beams in the preferred embodiment and is referred to as the R-mode configuration (reflective mode) because it uses a 45-degree dichroic filter (DF) for enabling illumination of the sample laterally to one side of the overall system. The filter is reflective for the NIR wavelength and transmissive for the visible wavelengths. This configuration of lenses and filters best accommodates the ability to read any kind of sample (S), sample format or surface to be interrogated, as opposed to the design of FIG. 2 which depicts a schematic for the T-mode configuration (transmissive mode) where only a sample holder in the middle of the system can be used and restricts the range of sample types. In either configuration, however, all of the lenses (L) in the preferred embodiment are of simple planoconvex type with equal clear apertures (D or diameter) and equal effective focal lengths (f) accommodating the numerical apertures and beam divergences of the input fiber (IF) and output fiber (OF). These characteristics ensure achieving optimal light capture, collimation and focusing for both the laser excitation beam (from IF) and the phosphorecence emissions transmitted back through the dichroic to the output fiber. The telecentricity of these systems allows for efficient capture, transmission and focusing of most of the light along the optical axis. This requires that the light is collimated with minimal beam divergence prior to entering the focusing lenses, and best performance in this regard is therefore dependent of obtaining optimal alignment and distance (f) of the lenses as well as the positions fiber facets along the optical axis. In the preferred embodiment (R-mode config.) lenses L1 and L2 are collimating lenses for the laser excitation beam and phosphorescence emission, respectively. Lens L2 also serves as the focusing lens for the laser beam. L3 serves as the focusing lens for the luminescence emission from the UCP containing sample. Also, lenses L2 and L3 in the R-mode (or L3 and L4 in the T-mode) can be achromatic lenses to help reduce chromatic aberrations. The filters (F) in the R-mode are positioned after the collimating lenses and can be used for different purposes. For instance F1 can be used as a band-pass filter to select specific excitation wavelengths from a broadband light source or to eliminate undesired spontaneous emissions from the laser. Filter F2 can serve to band-pass select specific luminescence emission wavelengths or as a short-pass filter to further filter out reflected laser light, if any. In the preferred embodiment, the excitation light sources are fiber-coupled diode lasers because their robustness in optical power, monochromatic wavelength availability for this application, small size and relatively low expense. Alternatively, free-space laser illumination (eliminating the input fiber) could also be used in principle. Band-pass filtered broadband light sources such as lamps and LEDs could also be used if they meet the power requirements needed to achieve similar performance in phosphor detection. Also, in the preferred embodiment, the detector is a fiber coupled mini-spectrometer with spectrograph and linear sensor array such as a CCD for the ability to separate and measuring discrete unfiltered luminescent emission spectra. However, it is also envisioned that single channel photodiode detectors could be used if able to achieve similar performance in selectivity and sensitivity of detection.

### BRIEF DESCRIPTION OF THE DRAWINGS

FIG. 1. The “Reflective Mode” (R-mode) configuration of the optical module, with ray tracing, for focusing a high intensity NUR excitation beam onto the phosphor-containing laterally positioned sample, and for focusing the VIS phosphorescence emission onto the output fiber to the spectrometer. See the text for a detailed description.

FIG. 2. The “Transmissive Mode” (T-mode) configuration of the optical module, with ray tracing, for focusing a high intensity NIR excitation beam onto the phosphor-containing center-positioned sample, and for focusing the VIS phosphorescence emission onto the output fiber to the spectrometer. See the text for a detailed description.

FIG. 3. The “Alpha Prototype” of the optical module, in R-mode configuration, mounted to an optical table and showing the XYZ translational stages used to obtain high precision special alignment of the lenses, dichroic filter and fiber facets on the optical axis. See the text for a detailed description.

FIG. 4. Block diagram schematic and footprint of a proposed compact spectrophotometric instrument showing a DFM module (design for manufacturing) discretely integrated via fiber optic interconnect with the excitation source and mini-spectrometer.

### DETAILED DESCRIPTION OF THE INVENTION

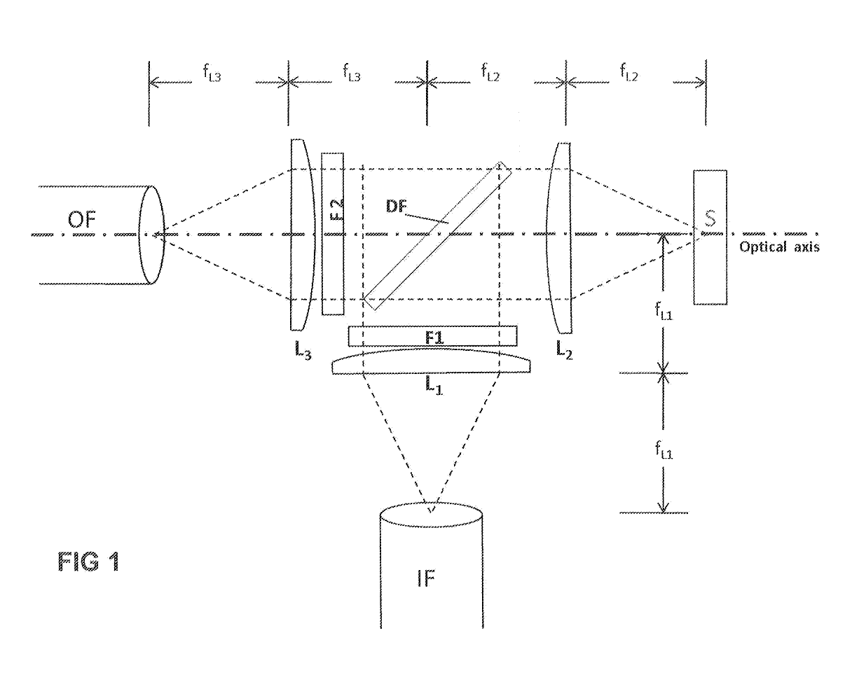

The invention described herein is cost-effective module design which when integrated as part of either a general spectrophotometric platform or application-specific reader enables the delivery and collection of excitation and luminescence intensities, respectively, necessary to obtain optimal upconversion compound signal detection. The preferred embodiment of the invention is a “Reflective Mode” (R-mode) configuration which enables optimal production and detection of upconversion signal from the lanthanide series of the NIR-to-visible upconversion phosphors and nanophosphors (UCPs) using a relatively low-power continuous wave laser diode as excitation light source and for a variety of applications as determined by the choice of the type of sample or surface containing the phosphors that is illuminated. The samples could be in a number of different formats, be solid or liquid and made of organic or inorganic material. For bioanalytic purposes examples of sample formats could be micro-cuvettes, lateral flow strips or microtiter plates. A design schematic of the R-mode system is shown in FIG. 1 with ray tracing (dotted line). It is referred to as R-mode because of the use of the 45°-dichroic filter (or mirror). Referring to the figure, the system consists of the following components: an input optical fiber, IF, and output optical fiber, OF; lenses L1, L2 and L3; 45-degree dichroic filter, DF;

sample holder, S, and optional filters, F1 and F2. The functions of these optical components are also discussed previously under “Brief Summary of the Invention.” In the preferred embodiment, fiber IF can support either a single-mode or multi-mode NIR laser beam of wavelength like 976 nm or 980 nm used for UCP absorption/excitation (the Yb3⁺ ground state absorption maximum). The lenses are of simple plano-convex type, and to satisfy the telecentric optics condition are of equal diameter or clear aperture, and of equal effective focal length (FL) depicted as fL1, fL2 and fL3 in the drawing. Alternatively, lenses L2 and L3 could be acromats to help correct for any chromatic aberrations. The dichroic filter, DF, when positioned at 45-degrees to the optical axis reflects NIR wavelengths toward the sample and is transmissive for visible light wavelengths emitted from the sample. The interference filters are optional and intended for use as either a 976 nm band-pass in the case of F1 to remove off-peak spontaneous emissions from the laser source, and as a short-pass filter in the case of F2 to remove any reflected or stray laser light reaching the output fiber and detector. However, the 45°-dichroic alone should (and does) serve as a good filter in these regard. An alternative to the 45°-dichroic filter is the use of a dichroic mirror/beam splitter with similar reflective/transmissive characteristics.

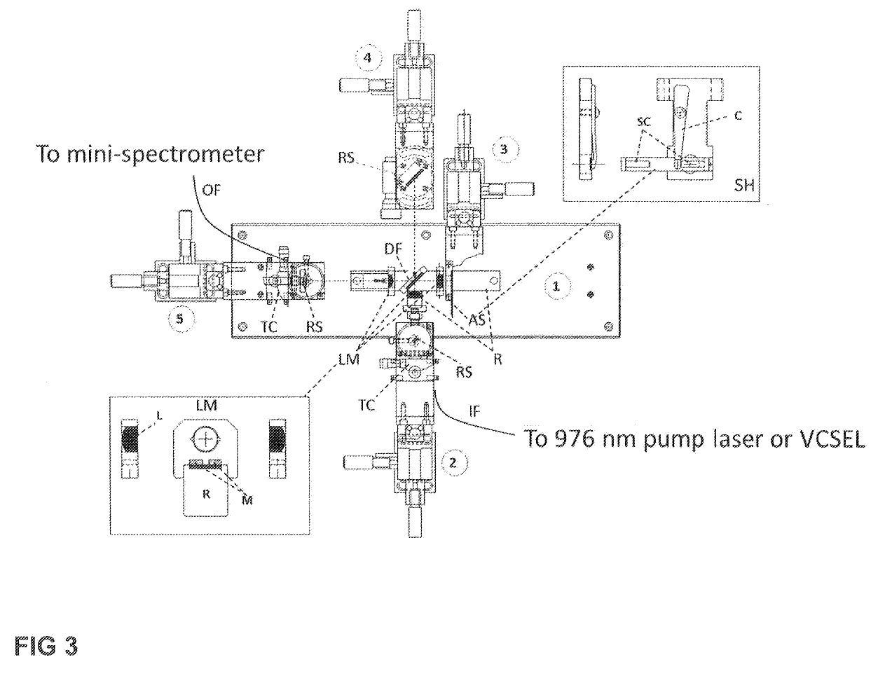

To ensure precise focusing and system telecentricity the distance between the system components (excluding F1 and F2) is ideally never more than two lens focal lengths, as shown in the drawing. The telecentric condition of the optical system described herein is designed such that the lenses and fibers, based on their numerical apertures (or F-numbers), when precisely aligned along the optical axis permit the total capture, collimation and focusing of the coherent laser beam to reproduce a spot size on the sample nearly equivalent in size to that of the point source which in the preferred embodiment is either a single-mode (SM) or multi-mode (MM) fiber exit aperture or the circular aperture of a single-mode or multimode laser diode (LD) or VCSEL. In the figure, IF to S is the illumination (excitation) path of the system and is akin to a microscope condenser in purpose. The luminescence detection path of the system is akin to a microscope objective in purpose (S to OF in the figure) except that the image formed on OF is measured as light intensity in a mini-spectrometer. Lenses L2 and L3 of this path collimate and focus, respectively, the noncoherent luminescence emission onto OF such that its image spot size is of near equivalence to the spot size of the laser point source and its focused spot onto the sample. Thus the entirety of the sample light emitted from the focused laser spot that can be captured, given the luminescence omnidirectionality, is imaged onto the OF facet for high resolution spectral readout in a spectrometer containing a high pixel density linear sensor array. But even more importantly, in contrast to most spectrophotometric systems on the market, the overall system can cost-effectively generate the entire phosphorescence cross section of the UCPs while yielding maximal efficiency of their emitted light power as a function of excitation intensity. FIG. 3 depicts an “alpha” prototype built on an optical table by the inventors and serves as a demonstrative example of the system which reduces the invention to practice. It is an F/1 system, however brightness of the sample image could easily be increased quadratically by further reducing F-number with the appropriate lenses.

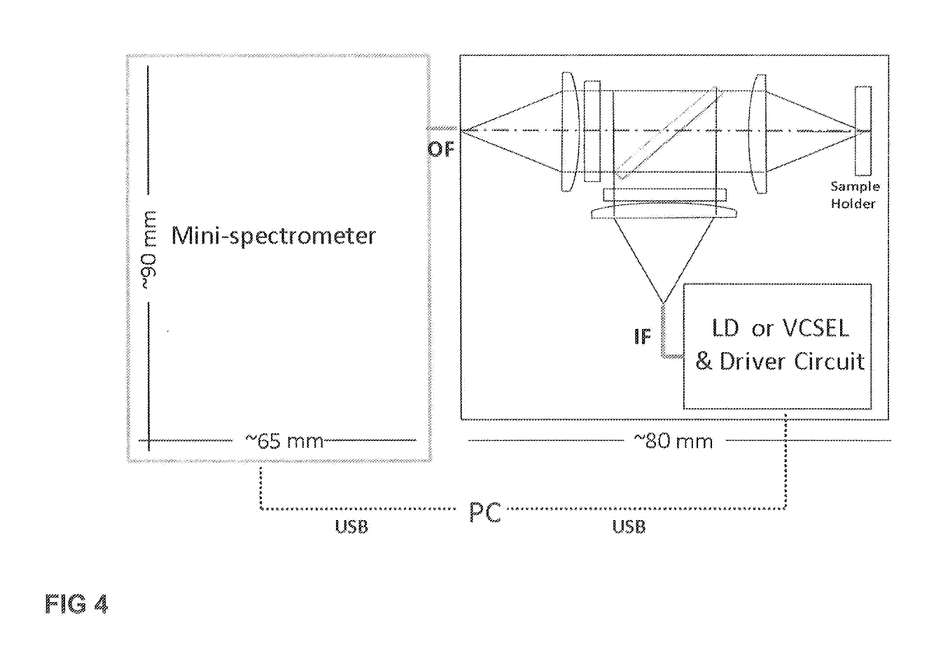

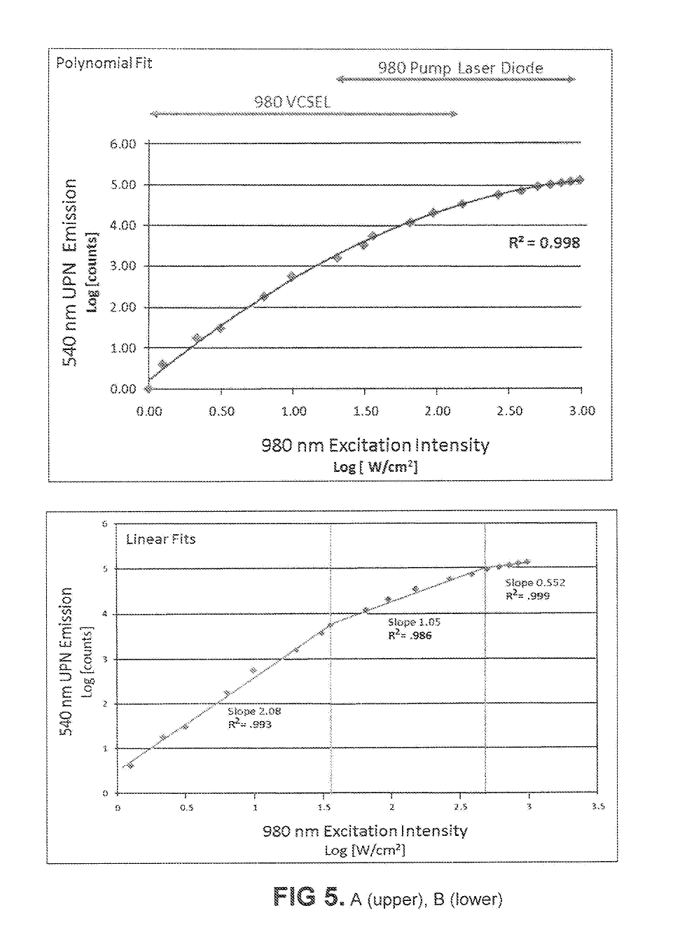

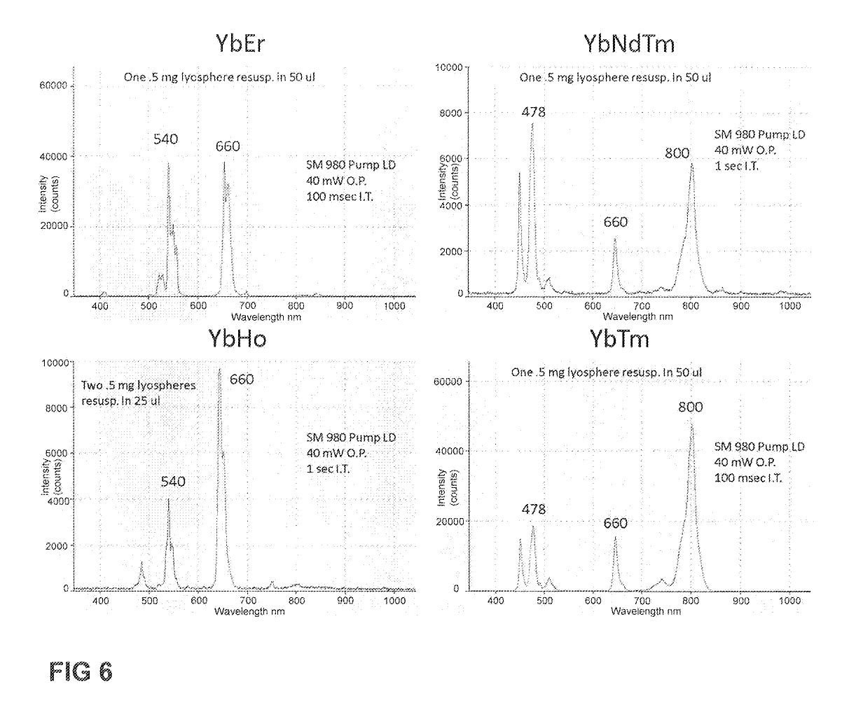

The alpha prototype simulates how the optical system might operate as a DFM module (design for manufacturing). In the preferred embodiment it is heterogeneously integrated with other commercially available discrete components, modules or subsystems as part of a spectrophotometric instrument where the interconnectivities used are its input and output fibers, as depicted in the block diagram of FIG. 4 (and simulated by alpha prototype of FIG. 3). The input fiber comes from either a low power consumption fiber-pigtailed edge-emitting LD or VCSEL, the current of which is controlled for CW operation by a laser diode driver of appropriate power. The output fiber goes to a mini-spectrometer such as the Ocean Optics USB4000-FL which is designed for high detection sensitivity to low-light fluorescence and high spectral resolution using a 3648-pixel CCD linear sensor array from 375-1100 nanometers. Of course, other brand spectrometers of similar bandwidth and sensitivity could be used as well. Exemplary dimensions of the overall platform are shown in FIG. 4 indicating it could be manufactured as a small and compact instrument, USB driven from a personal computer given its potential low power consumption (PC). Because it uses fiber optic interconnects, the spectrometer and optical module can also be stackable. Alternatively, in another design (not depicted), in lieu of using the OEM spectrometer, lens L3, and optical fiber, OF, could be eliminated in order to engineer the system for free-space collection of the collimated luminescence directly onto a blazed grating of a spectrograph for spectral separations using a CCD or CMOS linear image sensor. This would eliminate optical alignment tolerance concerns of focusing onto the output fiber, greatly facilitating manufacturability, further miniaturization and cost reductions.

Using off-the-shelf equipment for excitation and detection the inventors have already built and tested prototypes demonstrating feasibility of the spectrophotometric concept using both the R-mode and T-mode optics. The R-mode is herein referred to as the “Alpha Prototype” in the preferred embodiment. A top view drawing of this system's optics and mechanics is shown in FIG. 3. The 976 nm light source used was either a MM fiber-pigtailed VCSEL (OptiComp Corp.) or a SM fiber-pigtailed single-mode pump laser diode (Agere Systems) driven by either a Kiethley 2400 Sourcemeter or an SDL800 Laser Diode Drive (Spectra Diode Labs), respectively. These input fibers used were 3 ft in length and of either 50 um or 62.5 um and spectrometers which could be used instead. Referring to FIG. 3, the system is built on a base plate, 1, which is screwed down to a magnetic stainless steel top optical breadboard table and on which is centered the optical train consisting of lens (L) mounts, LM, which can be moved by sliding along the perpendicular rails, R, and kept fixed in position with bottom magnets, M (see lower insert depicting a typical lens mount, made here of anodized aluminum). The lenses L1, L2 and L3 are 12.5 mm in diameter and with 12.7-14 mm effective focal length such that F/#≈1 and can effectively accommodate the beam divergences expected from the laser or sample. The combined cost of the optical components (between the fibers) is only around $550, the lenses and filters having been purchased from Edmund Optics. Alignment and positioning of the optical components along the optical axis is accomplished using XYZ linear translational stages (Newport Corp.), 2-5, with micrometer actuator control for 0.5 inch travel for the input fiber (IF), 2, output fiber (OF), 5, sample holder (SH), 3, and dichroic filter (DF) holder, 4. The stages can be either screwed to the breadboard or mounted on magnetic bases, the latter being the case for stages 3 and 4 in the figure (not top viewable). Referring to the upper insert of the figure, the sample holder is designed to hold a plastic microfluidic cuvette (Specvette, from ALine, Inc. in this example), AS, in position with a swivel clamp, C, and which has two sample chambers, SC. The XYZ stages 2, 4, and 5 are also equipped with 360-degree continuous rotation stages, RS (Newport). The fiber holders are also equipped with a spring-loaded tilt controller, TC. The fiber holders attached to XYZ stages 2 and 5 are metal plates with FC-connectors for the fibers (not top viewable in the figure) and which expose the fiber facets and each end of the optical train. Note that for graphic clarity stages 4 and 5 are drawn as recessed from their normal positions which are indicated by the dotted arrows. There are a number of manufactures of translational or rotational staging as well as fiber connectors of the same or different types that could be used instead. Also, the shown system is not confined to the use of the ALine Specvette, and the inventors have fabricated similar micro-cuvettes made of glass which fit in the SH and perform equally as well. No other filters other than the 45°—dichroic are necessarily required, as was observed by the detection of little-to-no 980 nm emission.

FIG. 6 shows the results of four NaYF₄ nanocrystals analyzed containing the following rare earth (lanthanide) co-dopants: YbEr, YbHo, YbNdTm and YbTm. The nanocrystals were provided as lyopsheres by IMS (Intelligent Material Solution, Inc., Princeton, N.J.) and prepared for analysis by resuspending in deionized water. For the experiment shown, the samples were applied as 25 μl aliquots to AS (500 μm thickness Specvette) and excited with the 976 pump laser at 40 mW optical power. The upconversion spectra and emission intensities (counts) for the four samples are shown in the figure, and different integration times (I.T.) of the CCD, ranging from 40 msec to 1 sec were used depending on their known relative brightness and concentrations. Depending of the UCP, blue (478 nm, NdTm), green (540 nm, Er, Ho), red (660 nm, Er, Ho) and near-IR (800, Tm, NdTm) emissions are observed. These spectral profiles and their relative emission strengths were expected as they agree with those observed by IMS using another spectrophotometer which, however, detected the signals at orders of magnitude less sensitivity. Using the Specvette micro-cuvette, the sensitivity achieved to date in either the R-mode or T-mode is about 500 attomolar regardless of the UCP tested. To demonstrate adaptability to an industry standardized sample format, nearly identical spectra and signal strengths were also easily obtained using both top and bottom illumination of the wells of part of a (strapped on) clear-bottom 96-well microtiter plate containing 30 μl aliquots of the same nanocrystal preparations (results not shown). This particular sample format has wide utility especially in high-throughput screening applications like clinical diagnostic testing and pharmaceutical drug discovery. There is also an alternative way to construct the R-mode system whereby the positions of the input and output fibers are exchanged and a dichroic mirror/beam splitter or filter which is NIR-transmissive and MS-reflective is used. However, this construct offers no clear advantage.

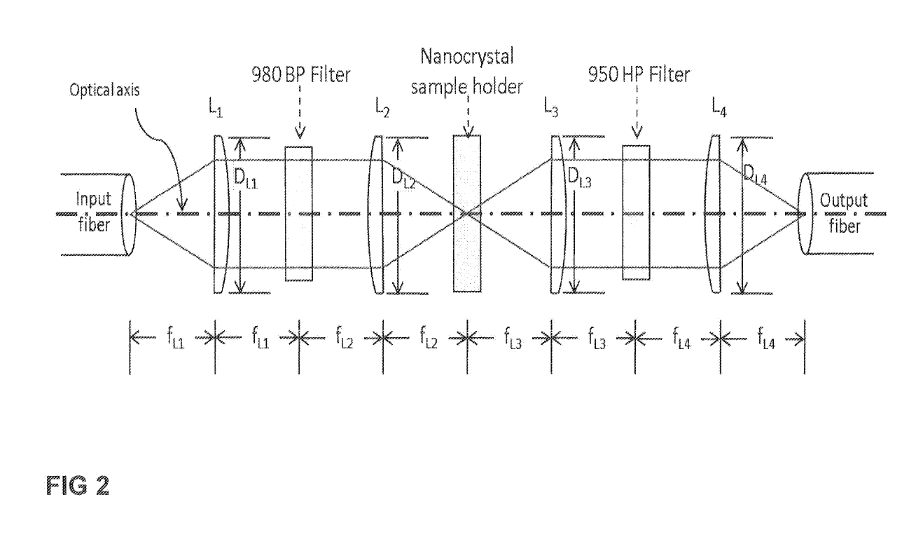

An alternative way to demonstrate the principle of the invention is in a “Transmission Mode” (T-mode) configuration as briefly discussed earlier and is depicted in the schematic of FIG. 2. This in fact was the original design for which a prototype was built and tested by the inventors and was demonstrated to generate results equivalent to that of the R-mode prototype. The T-mode places the sample holder in the system's single optical path axis between the illumination focusing lens (L2) and the luminescence collection/collimating lens (L3). Unlike the R-mode, this configuration also required the use of band-pass and/or short-pass filters to remove the 976 nm band and its spontaneous emissions. However, the biggest drawback to this system is the location of the sample which has small lateral clearances. The types of sample formats that can be accommodated by the T-mode are therefore obviously quite restricted in contrast to the R-mode. That is, a major convenience of the R-mode design is its lateral space availability (to the right side of S in FIG. 1) allowing almost any kind of sample format, sample size or surface to be interrogated. This advantage also permits more facile integration with automated sample linear or raster scanning devices such as step- or servo-motor controlled stages available from Semprex, Prior or Ludl. The R-mode design clearly has a much greater versatility and adaptability to multiple applications and markets.

There are many applications for which the invention, in particular the R-mode design, could be enabling. For example, the improved S/N and multiplexing potential of UCPs could greatly benefit multi-analyte systems such as flow cytometers or chip readers employing protein or DNA/RNA microarrays. Readers that perform point-of-care (or “point-of-use”) diagnostic tests could be developed which use the UCPs as reporters in assay formats that would benefit from improved S/N and dynamic range of detection such as in clinical applications interrogating complex sample matrices such as whole blood, plasma, saliva, urine and tissue. Systems or instruments that employ the widely used immunochromatographic lateral flow (LF) strips often used in the physician's office or at home could also benefit from the from the invention. Typically LF strips are made of nitrocellulose membranous material which also produces problematic background noise under UV or visible light illumination compared with NIR illumination. The inventors have in fact demonstrated feasibility of achieving high sensitivity of 540 nm-emitting UCPs in LF strips when mounted to the sample holder of the alpha prototype. A concentration curve of sample lines micro-sprayed onto the membrane was tested and 600 picogram/millimeter have been detected to date, and with a promise of achieving another 3-orders of magnitude sensitivity at longer CCD integration times. The small size and compactness potential of the invention as exemplified in FIG. 4, as well as its amenability to further miniaturization, should also enable the development of handheld, field deployable environmental monitors, food testers and biowarfare agent detection devices, to name a few. Construction of a high precision DFM module with tolerances in space akin to that allowed by the XYZ staging of the alpha prototype for housing in, for example, either a black anodized or injection molded chassis is possible with minimal innovation involved. Regardless of the application, the read-out of the wavelength-specific emission signals from either static or scanned UCP-containing samples could be done simply by targeting each of their peak intensities from a linear image sensor array or photodiode array or by measuring the incident photons onto a single-channel a photodiode or photomultiplier tube equipped with band pass filters selective for the specific emission wavelengths of interest in a given application. Also, and as mentioned earlier, sensitive phosphorimeters which include time-domain or frequency-domain measurements could be developed as well. With only minor modifications in the sample emission collection optics, if needed, the invention's adaptability to the development of many bench-top instruments and mobile devices is easily envisioned to enable many different applications across multiple disciplines including biomedicine, environmental monitoring, biodefense, homeland security, identification verification and authenticity testing.

### REFERENCES CITED

Non-blinking and photostable upconverted luminescence from single lanthanide doped nanocrystals (2009) Wu., S. et al. PNAS, 10917-10921
Up-Converting reporters for biological and other assays (2000), Kardos et al. U.S. Pat. No. 6,159,686
Absolute measurement of phosphorescent cross sections for upconverting phosphors (1998) Chen, Y. and G. Faris. Laser and Electra-Optics, 1998. CLEO 98. Technical Digest. Summaries of papers presented at the Conference on May 3-8, 1998, San Francisco, Calif. Pg. 229.
Up-Converting reporters for biological and other assays using laser excitation techniques (1997), Zarling, et al. U.S. Pat. Nos. 5,674,698, 5,698,397, 5,736,410

1. An optics system, the optical components (lens, filters, dichroic, and optical fibers) of which comprise the described Reflective Mode and Transmission Mode configurations, which uses low-power excitation light sources to enable the selective production and detection of the visible-emitting or near-infrared-emitting photoluminescence, including fluorescence and phosphorescence, of near-infrared absorbing up-converting compounds.

2. An optics system comprising:
a first optical submodule focusing an excitation beam onto a phosphor containing laterally positioned sample;
a second optical submodule focusing the emitted phosphor photoluminescence onto an output fiber.
an angled dichroic filter positioned to reflect the excitation beam for focusing the beam onto the phosphor containing sample in the first optical submodule and also positioned in the second optical submodule to permit the transmission and focusing of the photoluminescence onto an output fiber.

3. An optics system comprising:
an output fiber;
a first optical submodule focusing an excitation beam along a path which impinges upon the output fiber;
a phosphor containing sample positioned in the path and between the first optical submodule and the output fiber; and
a second optical submodule, positioned along the path and between the sample and the output fiber, focusing photoluminescence emissions from the sample onto the output fiber.

4. The optics system of claim 1, wherein the lens are, in the preferred embodiment, of spherical planoconvex or achromatic type and can be interchanged with other types of lens such as aspherized achromatic lenses.

5. The optics system of claim 1, wherein said band-pass, short-pass and dichroic filters can be of any UV, VIS or NIR wavelength transmissivity or reflectivity of choice depending on the application. A 45-degree dichroic mirror beam splitter can serve as well as the 45-degree dichroic filter.

6. The optics system of claim 1, wherein said input and output optical fibers can, in principle, be chosen to be of different core diameters and numerical apertures, which in turn might demand changing lens characteristics to match overall system performance.

7. The optics system of claim 1, wherein said low-power excitation source is either a near infrared emitting laser diode such as 976-980 nm, vertical cavity surface emitting laser (VCSEL), each of either single-mode or multi-mode emission, or selected wavelength radiation of a broadband light source.

8. The optics system of claim 1, wherein said excitation light source is delivered as an either pulsed or continuous wave (CW) operation.

9. The optics system of claim 1, wherein said upconverting compounds are, in the preferred embodiment, the lanthanide series of the NIR-to-VIS upconversion phosphors and nanophosphors (UCPs).

10. The optics system of claim 1, wherein said upconverting compounds, in the preferred embodiment, are the ytterbium (Yb) sensitized upconversion phosphors or nanophosphors.

11. The optics system of claim 1, wherein said excitation light source emission wavelength corresponds to, in the preferred embodiment, the near-infrared wavelength of the sensitizer dopant of the upconversion compounds such as 976-980 nm of ytterbium.

12. The optics system of claim 1, wherein said system is either an added-on or integrated modular component of either a spectrophotometric platform, including of the “Alpha Prototype” kind described, or an application-specific reader for selective excitation and emission of said upconversion compounds.

13. The optics system of claim 1, wherein said system a choice of detector types or components can be used, including spectrometers, photodiode arrays, CCD or CMOS linear image sensors, spectrographs, single-channel photodiodes, etc.

14. The optics system of claim 1, wherein said system is used for the interrogation and detection of upconversion compounds for a variety of solid or liquid samples or surfaces constituting organic or inorganic material.

15. The optics system of claim 1, wherein said system is used for the interrogation and detection of upconversion compounds used for the analysis biological samples such as blood, tissue, urine, etc.

16. The optics system of claim 1, wherein said system is used for the interrogation and detection of upconversion compounds used for the analysis of environmental samples such as soil, water, food, etc., and biowarfare or bioterrorism agents.

17. The optics system of claim 1, wherein said system is used for the interrogation and detection of upconversion compounds as a research tool for study of the compounds' photophysical properties.

18. The optics system of claim 1, wherein said system is used for the interrogation and detection of upconversion compounds as a research tool for study of the compounds' photophysical properties.

19. The optics system of claim 1, wherein said system is used for the interrogation and detection of upconversion compounds as a research tool for study of the compounds' photophysical properties.

20. The optics system of claim 1, wherein said system is used for the interrogation and detection of upconversion compounds as part of a compact bench-top or handheld instrument.

21. The optics system of claim 1, wherein said system is used for the interrogation and detection of upconversion compounds for a variety of biological or environmental sample formats, including, in the preferred embodiment, cuvettes, microcuvettes, microarrays, flow cytometry cells, microtiterplates, lateral flow strips, etc.

22. The optics system of claim 1, wherein said system is used for the interrogation and detection of upconversion compounds in a variety of liquids, solids or surfaces for security applications, including identity verification, product authenticity testing, etc.
